(19) United States
(12) Patent Application Publication
(10) Pub. No.: US 2012/0093715 A1
(43) Pub. Date: Apr. 19, 2012

(54) MONOLITHIC ZEOLITE STRUCTURES WITH AND WITHOUT HIERARCHICAL PORE STRUCTURES AND METHODS FOR PRODUCING THE SAME

(75) Inventor: Hui Wang, Des Plaines, IL (US)

(73) Assignee: UOP LLC, Des Plaines, IL (US)

(21) Appl. No.: 12/907,609

(22) Filed: Oct. 19, 2010

(51) Int. Cl. C01B 39/04; C01B 39/20; C01B 39/02

(52) U.S. Cl. 423/702; 423/710

(57) ABSTRACT

Monolithic zeolite structures with hierarchical pore structures and methods for producing monolithic zeolite structures without the use of a solid template are provided. A silica source, an alumina source, and a cation base are mixed to form a reaction mixture. The reaction mixture is aged under conditions sufficient to produce a precursor zeolite gel by hydrolysis. The precursor zeolite gel is heated at a temperature and for a period of time sufficient to crystallize and agglomerate the precursor zeolite gel into the monolithic zeolite structure. The addition of polymer to the reaction mixture provides the monolithic zeolite structure with a hierarchical pore structure.

### FIELD OF THE INVENTION

The present invention generally relates to zeolites and their production, and more particularly relates to monolithic zeolite structures with and without hierarchical pore structures and methods for producing the same.

### DESCRIPTION OF RELATED ART

Conventional zeolites have well-defined, microcrystalline structures and are therefore in powdered form. Conventional zeolites are synthesized hydrothermally from a solution having a high H₂0/Si molar ratio using a structure-directing agent to direct formation of the zeolite structure. Structure-directing agents are organic molecules used in zeolite synthesis that induce the synthesis gel to form certain types of zeolite structures. A common structure-directing agent is quaternary ammonium hydroxide (or chloride or bromide). For example, tetrapropylammonium hydroxide or bromide may be used as a structure-directing agent for a zeolite having an MFI framework.

Monolithic zeolites are also available, and may also be synthesized using a structure-directing agent. As used herein, “monolithic zeolites” are characterized as integral solid structures comprising internal void spaces (channels, cavities or the like) bounded by internal surfaces. Monolithic zeolites can have advantages over conventional zeolites in that they provide high permeability, low pressure drop, a large number of channels, cavities, or the like, and a high surface area available for reactivity. However, there is a continuing need for monolithic zeolites with improved properties for catalysis and separation technologies, as well as for other applications. Such improved properties include a larger surface areas and shorter diffusion path lengths, more ion exchangeable sites, higher chemical and thermal stability, and more easily modifiable via physical and chemical processes. These improved properties can lead to new applications in catalysis and separation technologies (e.g., in a high performance liquid chromatography (HPLC) column). Such improved properties are imparted by introducing larger pores to the generally microporous (less than about 2 nm) monolithic zeolites.

To produce pores of a diameter larger than 2 nm in zeolite structures (i.e., meso- and macropores), solid templates have been used. A solid template is typically comprised of relatively expensive organic compounds arranged in a solid network, as particles, or the like. The solid templates are physically hard to the touch. The use of such solid templates during zeolite synthesis adds to the expense and complexity of the synthesis process. After crystallization of the zeolite structure, the solid template is removed to form and define the size of the pores. It is also necessary to remove the solid template from the interior of the crystals because it would otherwise block existing pores, channels, etc. Removal of the solid template is accomplished by heating, thereby increasing processing complexity and cost. There are also environmental risks associated with the use of the solid templates, such as disposal of the organic compounds. The solid templates retain their morphology before and after zeolite crystallization.

Accordingly, it is desirable to provide monolithic zeolite structures that have an increased ion-exchange capability and porosity, providing improved diffusion properties, and a higher surface area for reactivity, resulting in an increase in catalytic and separation efficiencies. It is also desirable to provide a method for producing such monolithic zeolite structures without an external solid template.

Furthermore, other desirable features and characteristics of the present invention will become apparent from the subsequent detailed description of the invention and the appended claims, taken in conjunction with the accompanying drawings and this background of the invention.

### SUMMARY OF THE INVENTION

Methods are provided for producing a monolithic zeolite structure. In accordance with one exemplary embodiment, a method for producing a monolithic zeolite structure comprises mixing a silica source, an alumina source, and a cation base to form a reaction mixture. The reaction mixture is aged under conditions sufficient to produce a precursor zeolite gel by hydrolysis. The precursor zeolite gel is heated at a temperature and for a period of time sufficient to crystallize and agglomerate the precursor zeolite gel into the monolithic zeolite structure.

Methods are provided for producing a monolithic zeolite structure having a hierarchal pore structure in accordance with yet another exemplary embodiment of the present invention. The method comprises combining a silica source, an alumina source, a cation base, and a polymer to form a reaction mixture. The reaction mixture is aged under conditions sufficient to produce a precursor zeolite gel by hydrolysis. The precursor zeolite gel is heated at a temperature and for a period of time sufficient to produce a monolithic zeolite structure comprising agglomerated nanocrystalline zeolite crystals and having micropores, mesopores, and macropores.

Monolithic zeolitic structures having a hierarchical pore structure are provided in accordance with yet another exemplary embodiment. The monolithic zeolite structure with a hierarchical pore structure comprises a zeolite body having a silica:alumina molar ratio of about 1:1 to about 100:1. The hierarchal pore structure comprises pores having a diameter less than 2 nm, pores from 2 nm to 50 nm, and pores having a diameter greater than 50 nm.

### BRIEF DESCRIPTION OF THE DRAWINGS

The present invention will hereinafter be described in conjunction with the following drawing figures, wherein like numerals denote like elements, and wherein:

FIG. 1 is a flow chart of methods of producing a monolithic zeolite structure with and without a hierarchical pore structure according to exemplary embodiments of the present invention;

FIG. 2 is a series of SEM micrographs of monolithic zeolite structures prepared in accordance with exemplary embodiments. Each of the micrographs is identified with an Example number corresponding to the examples described below. All SEM images were acquired under identical settings having the same scale as depicted in the image for Example 1; and

FIG. 3 is a series of SEM micrographs of the monolithic zeolite structure with a hierarchical pore structure prepared in Example 2 below (13× magnified), illustrating the nanocrystalline zeolite crystals in the monolithic zeolite structure.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various exemplary embodiments of the present invention are directed to monolithic zeolites with hierarchical pore structures and methods for producing monolithic zeolites with and without hierarchical pore structures, as hereinafter described. The hierarchal pore structure comprises pores having a diameter less than 2 nm, pores from 2 nm to 50 nm, and pores having a diameter greater than 50 nm. The hierarchical pore structure imparts improved properties to the monolithic zeolites, such as larger surface areas and shorter diffusion path lengths, more ion exchangeable sites, high chemical and thermal stability, and easily modifiable via physical and chemical processes. The monolithic zeolites, with and without hierarchical pore structures, produced in accordance with exemplary embodiments are self-assembling. As used herein, “self-assembling” means that no external solid template is needed to direct formation of the zeolite structure during synthesis. As a result, the cost and complexity of synthesizing the monolithic zeolites with and without a hierarchical pore structures are reduced and the environmental risks associated with use of a solid template may be avoided. In addition, the monolithic zeolites, with hierarchical pore structures, have increased catalytic and separation efficiencies.

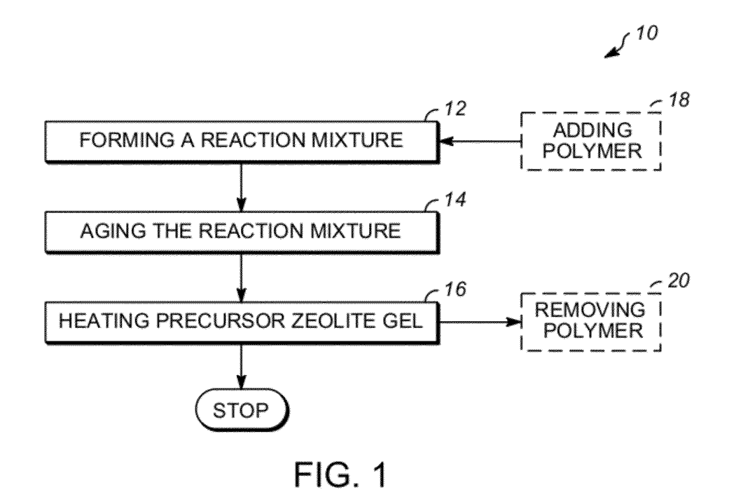

Referring to FIG. 1, in accordance with an exemplary embodiment, a method 10 for producing a monolithic zeolite structure begins by forming a reaction mixture (step 12). In an embodiment, the reaction mixture comprises a silica source, an alumina source, and a cation base that are mixed or combined to form the reaction mixture. A single component can be a source for both silica and alumina, silica and cation base, or alumina and cation base. For example, an amorphous aluminosilicate can be both the silica and alumina source and sodium aluminate can be both the alumina source and the cation base because sodium aluminate can be considered as a reacted mixture of alumina and sodium hydroxide. A structure-directing agent may also be added to the reaction mixture depending on the desired framework type. The structure-directing agent may also serve as a cation base. For example, when structure-directing agents are used in hydroxide form, they can also be serving as cation bases. For example, tetraethyammonium hydroxide can serve as both structure-directing agent and cation base. However, when tetraethyammonium bromide is used (as structure-directing agent), a cation base such as sodium hydroxide is needed.

The amounts of the silica source and alumina source are adjusted to form a monolithic zeolite with a Si/Al molar ratio from about 1:1 to about 100:1, and can be determined by one skilled in the art. Suitable exemplary silica sources include silicon dioxide, silicates such as sodium silicate, potassium silicate, silicic acid, and combinations thereof. The silica source may be a solid or a liquid. Suitable exemplary alumina sources include sodium aluminate, potassium aluminate, aluminum oxide, aluminum hydroxide, and combinations thereof. As noted previously, amorphous aluminosilicate can be a source for both silica and alumina. Amorphous aluminosilicate comprises activated clay such as kaolin clay, rice husk ash, or other synthetic or natural amorphous aluminosilicates as known to one skilled in the art. Therefore, for example, when forming a monolithic zeolite structure having the minimum silica:alumina molar ratio of about 1:1, amorphous aluminosilicates with Si/Al molar ratio of 1 may be used as both the silica source and the alumina source. When forming the monolithic zeolite structure having the maximum silica:alumina molar ratio of about 100:1, 1 part of amorphous aluminosilicate per 99 parts of an additional silica source is used.

The cation base comprises sodium hydroxide, potassium hydroxide, lithium hydroxide, quaternary ammonium hydroxide, or combinations thereof. The cation base has a concentration of about 1 to about 50 weight percent (wt. %) and is added in an amount to provide an OH⁻:Si/Al molar ratio of about 0.05 to about 5. A solvent may also be added to the reaction mixture. Suitable exemplary solvents include water, ethanol, or the like. The solvent may be used to dissolve components of the reaction mixture so that the reaction mixture is substantially homogenous. The solvent may be removed by evaporation to about 20 to about 70% Loss on Ignition (LOI at 900° C.). The reaction mixture has a relatively low water:silicon ratio. The water is derived from the cation base and any water in a liquid silica source.

It is to be understood that the framework of the monolithic zeolite produced in accordance with exemplary embodiments is dependent on the particular silica source, alumina source, cation base, or a combination thereof, that is used in the reaction mixture. Monolithic zeolite structures of framework types, including FAU, LTA, SOD, GIS, EMT, MFI, BEA, and combinations thereof may be produced. For example, a monolithic Zeolite X structure having a faujasite framework may be produced using a reaction mixture comprised of kaolin clay, sodium silicate, and sodium hydroxide. A monolithic zeolite having an LTA framework may be produced, for example, by using kaolin clay and NaOH; kaolin clay, sodium aluminate, sodium silicate, and NaOH; or silica and sodium aluminate. The sodium aluminate in the last example is also serving as the cation base in the reaction mixture. A monolithic zeolite having an MFI framework with a Si/Al molar ratio greater than 1 may be produced by using the aluminosilicate, for example, rice husk ash, the silicate, for example, silicic acid, and the cation base, for example, tetrapropylammonium hydroxide. In this example, the tetrapropylammonium hydroxide also serves as a structure-directing agent.

In accordance with another embodiment, the step of forming the reaction mixture further comprises adding a polymer (step 18) to the reaction mixture to provide a hierarchical pore structure to the subsequently-formed monolithic zeolite structure, as hereinafter described. It is thus to be understood that the reaction mixture without the polymer forms the monolithic zeolite structure without a hierarchical pore structure. The polymer acts as a template, but unlike solid templates, the polymer does not have a particular morphology. Their templating effect is determined by the solubility, rate of solvent/water consumption, and the interaction between the zeolite and the polymer. Therefore, different pore sizes may be templated by the same polymer under different conditions. Suitable exemplary polymers include polyethylene glycol (PEG), di-block and tri-block polymers such as poly(ethylene glycol)-block-poly(propylene glycol), poly(ethylene glycol)-block-poly(propylene glycol)-block-poly(ethylene glycol) (available from, for example, BASF Global Corporation), polyetheramine (available from Huntsman Corporation, The Woodlands, Tex.), polyethylene-block-poly(ethylene glycol), and combinations thereof. The amount of polymer added to the reaction mixture comprises about 0.01 wt % to about 50 wt % of the total weight of the monolithic zeolite structure on a volatile-free basis.

Referring again to FIG. 1, method 10 continues by aging the reaction mixture under conditions sufficient to produce a precursor zeolite gel by hydrolysis (and until substantially no free water is observed) (step 14). Such conditions include aging the reaction mixture for about 4 hours to about 10 days (240 hours) at a temperature of about 0° C. to about 50° C., preferably 25° C. in a sealed container comprised of a non-reactive material. The precursor zeolite gel is an amorphous solid. During the aging step, the free water in the reaction mixture is absorbed forming hydroxyl groups as the water is consumed. If polymer was added to the reaction mixture, when the water is consumed, the polymer molecules are segregated from the zeolite phase, thus templating macropores in the precursor zeolite gel. As used herein, “macropores” are defined as pores having a pore diameter greater than 50 nm and less than 100 microns.

Referring still to FIG. 1, method 10 continues by heating the precursor zeolite gel at a temperature and for a period of time sufficient to crystallize and agglomerate the precursor zeolite gel into the monolithic zeolite structure comprised of nanocrystalline zeolite crystals, which themselves have well-defined micropores (step 16). As used herein, the term “micropores” is defined as pores having a pore diameter less than about 2 nm. As “nanocrystalline” zeolite crystals, the crystals have one or more dimensions on the order of about 100 nm or less. The precursor zeolite gel may be heated at a temperature of about 25° C. to about 200° C. for a period of time of about 4 hours to about 20 days (480 hours). Agglomeration and crystallization occur substantially simultaneously during the heating step. The precursor zeolite gel may be heated by conventional heating means as known to one skilled in the art. Unlike conventional formation of zeolite structures that requires an external solid template, the monolithic zeolite structure is self-assembling, i.e., no external solid template is used or is necessary. The heating step converts the amorphous solid precursor zeolite gel into the solid monolithic (non-amorphous) zeolite structure. In general, the lower the heating temperature, the smaller the size of the zeolite crystals in the monolithic zeolite structure. If polymer has been added to the reaction mixture, the polymer creates space for additional macropores, and mesopores are formed in the space between the crystals. As used herein, the term “mesopores” is defined as pores having a pore diameter between about 2 and about 50 nm.

The monolithic zeolite structure produced in accordance with exemplary embodiments of the present invention comprises a solid zeolite body with a silica:alumina molar ratio in the range of about 1:1 to about 100:1. The monolithic zeolite structure may be a shaped or unshaped body. As noted previously, the monolithic zeolite structure may be provided with a hierarchical pore structure (by adding polymer to the reaction mixture). The hierarchical pore structure comprises the three types of pores, micropores, mesopores, and macropores.

Referring again to FIG. 1, the polymer may optionally be removed from the monolithic zeolite structure with the hierarchical pore structure (step 20). If the polymer has a functionality (other than contributing to form the hierarchical pore structure), removal may be undesirable. A water-soluble polymer may be removed from the monolithic zeolite structure with a hierarchical pore structure by, for example, washing the structure with water or the like. Calcination at above 500° C. can also be used to remove the polymer without jeopardizing the integrity of the monolith.

### EXAMPLES

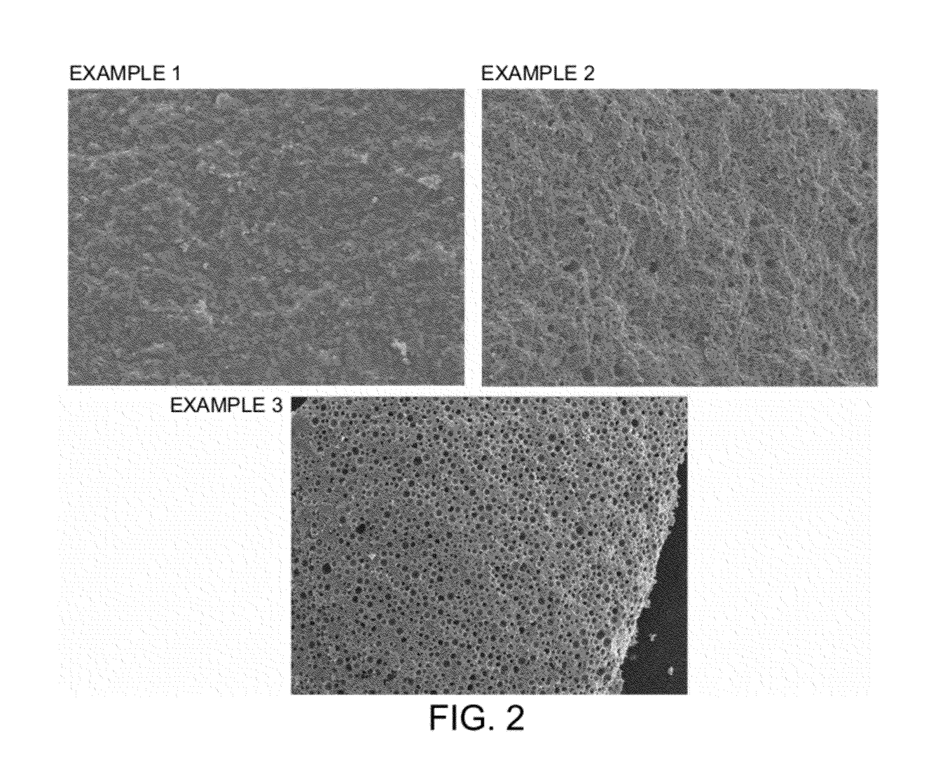

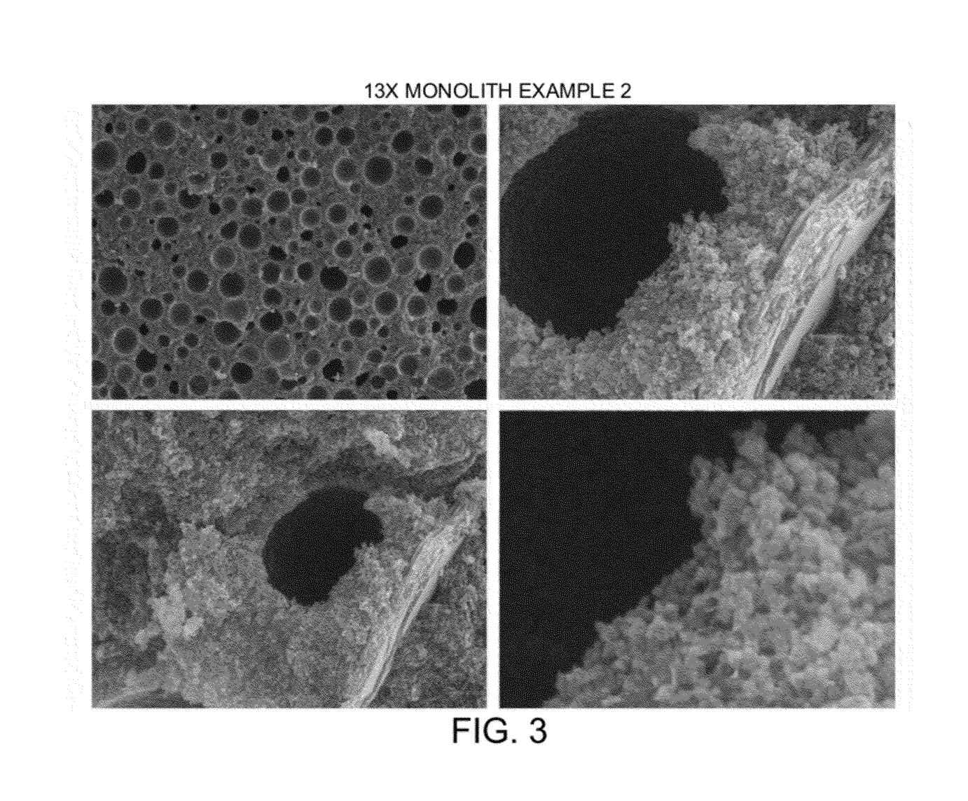

The following examples represent exemplary production of monolithic zeolites with and without a hierarchical pore structure, in accordance with exemplary embodiments. The examples are provided for illustration purposes only, and are not meant to limit the various embodiments of the present invention in any way. The monolithic zeolites with and without a hierarchical pore structure produced in accordance with these examples were evaluated qualitatively (visually) for porosity (comparison of the pores with the reference sample (Example 1)), by scanning electron micrography (SEM) as shown in the SEM micrographs of FIGS. 2 and 3, and by measuring pore volume by Hg intrusion porosimetry.

### Example 1 (Reference Sample)

16 grams of Anhydrol (activated kaolin clay) were mixed with 12 grams of liquid sodium silicate (6.7% by weight sodium (Na), 13.6% by weight silicon (Si)) (OxyChem, Dallas, Tex. (USA)), 11.6 grams of 50% NaOH solution, and 2.2 grams deionized (DI) H₂O in a mortar for 5 minutes. The resultant sticky paste was charged into a plastic container and sealed. After aging at room temperature (about 25° C.) for 2 days (24 hours), no free liquid was observed. The hardened gel was then heated at 90° C. for 3 days (36 hours). The resultant monolithic zeolite structure without hierarchical pore structure is shown in FIG. 2. The monolithic zeolite structure is an X Zeolite having a faujasite (FAU) framework.

### Example 2

16 grams of Anhydrol were mixed with 12 grams of liquid sodium silicate (6.7% by weight sodium, 13.6% by weight Si), 12 grams of 50% NaOH solution, and 12 grams 50% polyethylene-glycol (PEG) solution (molecular weight of 1500) in a mortar for 5 minutes. The resultant sticky paste was charged into a plastic container and sealed. After aging at room temperature for 2 days, no free liquid was observed. The hardened gel was then heated at 90° C. for 3 days. The polymer was removed by washing. The resultant monolithic zeolite structure with hierarchical pore structure is shown in FIGS. 2 and 3 and is an X Zeolite having a faujasite (FAU) framework.

### Example 3

16 grams of Anhydrol were mixed with 12 grams of liquid sodium silicate (6.7% by weight Na, 13.6% by weight Si), 14 grams of 50% NaOH solution, and 20 grams 50% PEG solution (M.W. 1500) in a mortar for 5 minutes. The resultant sticky paste was charged into a plastic container and sealed. After aging at room temperature for 4 days, no free liquid was observed. The hardened gel was then heated at about 70° C. for 3 days. The polymer was removed by washing. The resultant monolithic zeolite structure with hierarchical pore structure is shown in FIG. 2 and is an X Zeolite having a faujasite (FAU) framework. The increased amount of polymer results in more macropores than in the monolithic zeolite structure of Example 2, as shown in FIG. 2. The crystals of Example 3 are smaller than the crystals of the monolithic zeolite structure of Example 1 because the heating temperature is lower (not shown).

The pore volume of each of the monolithic zeolites produced in Examples 1-3 were measured by Hg intrusion porosimetry using N₂ absorption to determine BET (Brunauer, Emmet, and Teller) surface area, a process known to one skilled the art. The results are shown below in Table 1:

| | Hg intrusion | Hg intrusion | BET external | |
|---|---|---|---|---|
| | porosity, | total pore area, | surface area, | Mesopore |
| Example | cc/g | m²/g | m²/g^{a} | volume, cc/g^{b} |
| 1 | 0.352 | 26 | 21 | 0.096 |
| 2 | 0.598 | 25 | 34 | 0.113 |
| 3 | 0.894 | 118 | 112 | 0.322 |

^{a}Calculated by substracting micropore area from BET total surface area.
^{b}Calculated by substracting micropore volume from BET total pore volume.

From the foregoing, it is to be appreciated that the monolithic zeolites with and without a hierarchical pore structure produced in accordance with exemplary embodiments of the present invention are self-assembling, have an increased ion-exchange capability and porosity, providing improved diffusion properties, and a high surface area for reactivity, resulting in an increase in catalytic and separation efficiencies.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for producing a monolithic zeolite structure, the method comprising the steps of:
mixing a silica source, an alumina source, and a cation base to form a reaction mixture;
aging the reaction mixture under conditions sufficient to produce a precursor zeolite gel by hydrolysis; and
heating the precursor zeolite gel at a temperature and for a period of time sufficient to crystallize and agglomerate the precursor zeolite gel into the monolithic zeolite structure.

2. The method of claim 1, further comprising the step of adding a polymer to the reaction mixture to provide a hierarchical pore structure to the monolithic zeolite structure.

3. The method of claim 2, wherein the step of adding the polymer comprises adding polyethylene glycol (PEG), poly(ethylene glycol)-block-poly(propylene glycol), poly(ethylene glycol)-block-poly(propylene glycol)-block-poly(ethylene glycol), polyetheramine, polyethylene-block-poly(ethylene glycol), and combinations thereof.

4. The method of claim 2, further comprising the step of removing the polymer.

5. The method of claim 4, wherein the step of removing the polymer comprises washing or calcinating the monolithic zeolite structure.

6. The method of claim 1, wherein the step of mixing comprises selecting an alumina source from the group consisting of an amorphous aluminosilicate, sodium aluminate, potassium aluminate, aluminum oxide, aluminum hydroxide, and combinations thereof, the amorphous aluminosilicate also comprising the silica source.

7. The method of claim 1, wherein the step of mixing comprises selecting a cation base from the group consisting of sodium hydroxide, potassium hydroxide, lithium hydroxide, quarternary ammonium hydroxide, and combinations thereof.

8. The method of claim 1, wherein the step of mixing comprises selecting a silica source from the group consisting of sodium silicate, potassium silicate, silicic acid, and combinations thereof.

9. The method of claim 1, wherein the step of mixing comprises adding a solvent to the reaction mixture.

10. The method of claim 1, wherein the step of aging comprises aging for about 4 hours to about 10 days.

11. The method of claim 1, wherein the step of aging comprises aging at a temperature of about 0° C. to about 50° C.

12. The method of claim 1, wherein the step of heating comprises forming a monolithic zeolite structure having a zeolite framework type selected from the group consisting of FAU, LTA, SOD, GIS, EMT, MFI, BEA, and combinations thereof.

13. The method of claim 1, wherein the step of heating comprises heating at a temperature of about 25° C. to about 200° C.

14. The method of claim 1, wherein the step of heating comprises heating for a period of time of from about 4 hours to about 20 days.

15. A method for producing a monolithic zeolite structure having a hierarchal pore structure, the method comprising the steps of:
combining a silica source, an alumina source, a cation base, and a polymer to form a reaction mixture;
aging the reaction mixture under conditions sufficient to produce a precursor zeolite gel by hydrolysis; and
heating the precursor zeolite gel at a temperature and for a period of time sufficient to produce a monolithic zeolite structure comprising agglomerated nanocrystalline zeolite crystals and having micropores, mesopores, and macropores.

16. The method of claim 15, further comprising the step of removing the polymer from the monolithic zeolite structure.

17. The method of claim 15, wherein the step of aging comprising aging for about 4 hours to about 10 days at a temperature of about 25° C.

18. The method of claim 15, wherein the step of heating comprises heating at a temperature of about 25° C. to about 200° C. for a period of time of about 4 hours to about 20 days.

19. A monolithic zeolite structure having a hierarchal pore structure comprising:
a zeolite body having a silica:alumina molar ratio of about 1:1 to about 100:1 and a hierarchal pore structure comprising pores having a diameter less than 2 nm, pores from 2 nm to 50 nm, and pores having a diameter greater than 50 nm.

20. The monolithic zeolite structure of claim 19, further comprising polymer within the pores having a diameter greater than 50 nm.
